(19) United States
(12) Patent Application Publication
(10) Pub. No.: US 2017/0136715 A1
(43) Pub. Date: May 18, 2017

(54) AQUEOUS POLYURETHANEUREA COMPOSITIONS INCLUDING DISPERSIONS AND FILMS

(71) Applicant: INVISTA NORTH AMERICA S.A R.L., Wilmington, DE (US)

(72) Inventors: Kenneth Edward MARTIN, Newark, DE (US); Hong LIU, Waynesboro, VA (US); Kofi BISSAH, Newark, DE (US)

(73) Assignee: INVISTA NORTH AMERICA S.A R.L., WILMINGTON, DE (US)

(21) Appl. No.: 15/315,394

(22) PCT Filed: Jun. 10, 2015
(86) PCT No.: PCT/US2015/035106

§ 371 Date: Dec. 1, 2016

Related U.S. Application Data
(60) Provisional application No. 62/010,832, filed on Jun. 11, 2014.
(60) Provisional application No. 62/103,449, filed on Jan. 14, 2015.

(51) Int. Cl. B29C 70/30; C08K 7/02; C08G 18/08

(52) U.S. Cl. CPC B29C 70/30; C08G 18/0866; C08K 7/02; B29K 2075/00

(57) ABSTRACT

An article comprising a polyurethane composition and an array of fibers wherein said array of fibers are embedded in said polyurethane composition such that a portion of said fibers extends beyond an internal surface of said molded article and an external surface of said molded article.

### BACKGROUND OF THE INVENTION

Field of the Invention

Included are polyurethane articles include fibers or fabrics. These can be molded polyurethane articles that include an array of fibers embedded in the surface or a fabric impregnated with a polyurethane. The articles are prepared using a polyurethane dispersion.

Summary of Related Technology

Latex or rubber are known to be used in a variety of molded articles such as gloves, finger cots, etc. However, given the prevalence of allergies, especially to latex, alternative polymers may be desired.

### SUMMARY OF THE INVENTION

When included in a garment, a molded article or other substrate that has a skin contacting surface, a polyurethane composition may be more desirable to replace natural latex or rubber. Ideally, the polyurethane would provide the flexibility and elasticity of the incumbent.

Some embodiments provide a molded article including a polyurethane composition and an array of fibers wherein said array of fibers are embedded in the polyurethane composition such that a portion of the fibers extends beyond an internal surface of the molded article and an external surface of the molded article.

One suitable polyurethane dispersion includes a polymer which is the reaction product of:

(a) at least one polyol selected from polyethers, polyesters, polycarbonates, and combinations thereof, wherein the polyol has a number average molecular weight of 600 to 4000;

(b) a polyisocyanate comprising a member selected from the group consisting of aromatic diisocyantes, aliphatic diisocyanates, cycloaliphatic diiosocyanates, and combinations thereof;

(c) at least one diol compound comprising: (i) hydroxy groups capable of reacting with polyisocyanate, and (ii) at least one carboxylic acid group capable of forming a salt upon neutralization, wherein said at least one carboxylic acid group is incapable of reacting with the polyisocyanate;

(d) a neutralizing agent; and

(e) a chain extender. Also provided is a method of preparing a molded article. The method includes:

(a) providing a mold having an article contacting surface, wherein the article contacting surface includes a surfactant or wetting agent;

(b) applying an internal array of fibers to the article contacting surface;

(c) applying a polyurethane dispersion to the array of fibers;

(d) applying an external array of fibers to the dispersion;

(e) drying the article;

(f) removing the article from said mold.

Also provided is a method of preparing a molded article. The method includes:

(a) providing a mold having an article contacting surface, wherein the article contacting surface includes a surfactant or wetting agent;

(b) optionally applying an internal array of fibers to the article contacting surface, this may be excluded where fibers are only required on an external surface;

(c) applying a polyurethane dispersion to the array of fibers;

(d) optionally applying an external array of fibers to the dispersion, this may be excluded where fibers are only required on an internal surface;

(e) drying the article;

(f) removing the article from said mold.

An article which has been coated and/or impregnated with a polyurethaneurea composition is also included. The article may include a fabric such as a nonwoven sheet. The nonwoven may be any suitable nonwoven such as spunlace or hydroentangled nonwoven.

Also provided is an article including a polyurethaneurea composition and an array of fiber and/or a fabric, which may be a nonwoven. The polyurethaneurea composition includes a dispersion, which can be applied to the article, substrate, mold, etc. The dispersion may include One suitable polyurethane dispersion includes a polymer which is the reaction product of:

(a) at least one polyol selected from polyethers, polyesters, polycarbonates, and combinations thereof, wherein the polyol has a number average molecular weight of 600 to 4000;

(b) a polyisocyanate comprising a member selected from the group consisting of aromatic diisocyantes, aliphatic diisocyanates, cycloaliphatic diiosocyanates, and combinations thereof, such as a polyisocyanate that includes only an aliphatic diisocyanate;

(c) at least one diol compound comprising: (i) hydroxy groups capable of reacting with polyisocyanate, and (ii) at least one carboxylic acid group capable of forming a salt upon neutralization, wherein said at least one carboxylic acid group is incapable of reacting with the polyisocyanate;

(d) a neutralizing agent; and

(e) a chain extender.

In a further embodiment are processes for preparing polyurethaneurea aqueous dispersions useful for molded articles. Stable dispersions may be prepared on a commercial scale, including batches of greater than about 500 gallons, and greater than about 1000 gallons.

### DETAILED DESCRIPTION OF THE INVENTION

Aqueous polyurethane dispersions useful for preparation of molded articles are provided from particular urethane prepolymers, which also form an aspect of some embodiments.

In some embodiments, a segmented polyurethaneurea for making a polyurethaneurea dispersion includes: a) a polyol or a polyol copolymer or a polyol mixture of number average molecular weight between 500 to 5000 (such as from about 600 to 4000 and 600 to 3500), including but not limited to polyether glycols, polyester glycols, polycarbonate glycols, polybutadiene glycols or their hydrogenated derivatives, and hydroxy-terminated polydimethylsiloxanes; b) a polyisocyanate including diisocyanates such as aliphatic diisocyanates, aromatic diisocyanates and alicyclic diisocyanates; and c) a diol compound d including: (i) hydroxy groups capable of reacting with polyisocyanate, and (ii) at least one carboxylic acid group capable of forming a salt upon neutralization, wherein the at least one carboxylic acid group is incapable of reacting with the polyisocyanate; d) a chain extender such as water or an diamine chain extender; and e) optionally a monoalcohol or monoamine, primary or secondary, as a blocking agent or chain terminator; and optionally an organic compound or a polymer with at least three primary or secondary amine groups.

The urethane prepolymers of some embodiments, also known as capped glycols, can generally be conceptualized as the reaction product of a polyol, a polyisocyanate, and a compound capable of salt-forming upon neutralization, before the prepolymer is dispersed in water and is chain-extended. Such prepolymers can typically be made in one or more steps, with or without solvents which can be useful in reducing the viscosity of the prepolymer composition.

Depending on whether the prepolymer is dissolved in a less volatile solvent (such as NMP) which will remain in the dispersion; dissolved in a volatile solvent such as acetone or methylethyl ketone (MEK), which can be later removed; or is dispersed in water without any solvent; the dispersion preparation process can be classified in practice as the solvent process, acetone process, or prepolymer mixing process, respectively. The prepolymer mixing process has environmental and economic advantages, and may be used in the preparation of aqueous dispersion with substantially no added solvent.

In the prepolymer mixing process, it is important that the viscosity of the prepolymer is adequately low enough, with or without dilution by a solvent, to be transported and dispersed in water. One embodiment relates to polyurethaneurea dispersions derived from such a prepolymer, which meet this viscosity requirement and do not have any organic solvent in the prepolymer or in the dispersion. In accordance with the invention, the prepolymer is the reaction product of a polyol, a diisocyanate and a diol compound.

Some embodiments are solvent-free, stable, aqueous polyurethane dispersions, which can be processed and applied directly as adhesive materials (i.e., without the need of any additional adhesive materials) for coating, bonding, and lamination of to substrates, by conventional techniques. Aqueous polyurethane dispersions may be provided with: essentially no emission of volatile organic materials; acceptable curing time in production; and good adhesion strength, heat resistance, and stretch/recovery properties in finished products and in practical applications.

The substrate may be any of a number of different fabrics or articles.

As used herein, the term “dispersion” refers to a system in which the disperse phase consists of finely divided particles, and the continuous phase can be a liquid, solid or gas.

As used herein, the term “aqueous polyurethane dispersion” refers to a composition containing at least a polyurethane or polyurethane urea polymer or prepolymer (such as the polyurethane prepolymer described herein), optionally including a solvent, that has been dispersed in an aqueous medium, such as water, including de-ionized water.

As used herein, the term “solvent,” unless otherwise indicated, refers to a non-aqueous medium, wherein the non-aqueous medium includes organic solvents, including volatile organic solvents (such as acetone) and somewhat less volatile organic solvents (such as N-methylpyrrolidone (NMP)).

As used herein, the term “solvent-free” or “solvent-free system” refers to a composition or dispersion wherein the bulk of the composition or dispersed components has not been dissolved or dispersed in a solvent.

As used herein, the term “fabric” is meant to include any knitted, woven or nonwoven material. Knitted fabrics may be flat knit, circular knit, warp knit, narrow elastic, or lace. Woven fabrics may be of any construction, for example sateen, twill, plain weave, oxford weave, basket weave, or narrow elastic. Nonwoven materials may be one of meltblown, spun bonded, wet-laid, carded fiber-based staple webs, and the like.

As used herein, the term “hard yarn” refers to a yarn which is substantially non-elastic.

As used herein, the term “derived from” refers to forming a substance out of another object. For example, a film or molded article may be derived from a dispersion which has been dried.

Another advantage of the films cast from the aqueous dispersions of some embodiments is with respect to the feel or tactility of the films. They provide a softer feel compared to silicone rubber or the commercially available thermoplastic films while maintaining the desired friction to reduce movement that is a further advantage for skin contact applications. Also lower bending modulus gives better drape and fabric hand. The inclusion of an array of fibers provides and additional improvement to the feel of the films which form an article.

Depending on the desired effect of the polyurethane or polyurethaneurea composition when applied as a dispersion from the aqueous dispersion described herein, the weight average molecular weight of the polymer in the film may vary from about 40,000 to about 250,000, including from about 40,000 to about 150,000; from about 100,000 to about 150,000; and about 120,000 to about 140,000.

A variety of different fibers and yarns may be used with the articles of some embodiments, which may be molded articles. These include cotton, wool, acrylic, polyamide (nylon), polyester, spandex, regenerated cellulose, rubber (natural or synthetic), bamboo, silk, soy, polyolefin, such as polyethylene or polypropylene, which may or may not be elastomeric, or combinations thereof. The fiber may be elastic, such as an elastomeric fiber or an elastic fiber from a non-elastomeric polymer in a side-by-side or eccentric sheath-core cross-section. Short fibers are most useful to obtain the array of fibers which extends beyond the surface of the article. The fibers may be referred to as staple fibers. Alternatively, short fibers may be referred to as flock.

The components of the polyurethane compositions are described in more detail below:

### Polyols

Polyol components suitable as a starting material for preparing urethane prepolymers, according to the invention, are polyether glycols, polycarbonate glycols, and polyester glycols of number average molecular weight of about 600 to about 3,500 or about 4,000.

Examples of polyether polyols that can be used include those glycols with two or more hydroxy groups, from ring-opening polymerization and/or copolymerization of ethylene oxide, propylene oxide, trimethylene oxide, tetrahydrofuran, and 3-methyltetrahydrofuran, or from condensation polymerization of a polyhydric, alcohol, preferably a diol or diol mixtures, with less than 12 carbon atoms in each molecule, such as ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polyether polyol is preferred, and a poly(tetramethylene ether) glycol of molecular weight of about 1,700 to about 2,100, such as Terathane® 1800 (Invista) with a functionality of 2, is particularly preferred in the present invention.

Examples of polyester polyols that can be used include those ester glycols with two or more hydroxy groups, produced by condensation polymerization of aliphatic polycarboxylic acids and polyols, or their mixtures, of low molecular weights with no more than 12 carbon atoms in each molecule. Examples of suitable polycarboxylic acids are malonic acid, succinic acid, glutaric acid, adipic acid, pimelic acid, suberic acid, azelaic acid, sebacic acid, undecanedicarboxylic acid, and dodecanedicarboxylic acid. Examples of suitable polyols for preparing the polyester polyols are ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear bifunctional polyester polyol with a melting temperature of about 5° C. to about 50° C. is preferred.

Examples of polycarbonate polyols that can be used include those carbonate glycols with two or more hydroxy groups, produced by condensation polymerization of phosgene, chloroformic acid ester, dialkyl carbonate or diallyl carbonate and aliphatic polyols, or their mixtures, of low molecular weights with no more than 12 carbon atoms in each molecule. Examples of suitable polyols for preparing the polycarbonate polyols are diethylene glycol, 1,3-propanediol, 1,4-butanediol, 1,5-pentanediol, 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polycarbonate polyol with a melting temperature of about 5° C. to about 50° C. is preferred.

### Polyisocyanates

Examples of suitable polyisocyanate components include diisocyanates such as 1,6-diisocyanatohexane, 1,12-diisocyanatododecane, isophorone diisocyanate, trimethyl-hexamethylenediisocyanates, 1,5-diisocyanato-2-methylpentane, diisocyanato-cyclohexanes, methylene-bis(4-cyclohexyl isocyanate), tetramethyl-xylenediisocyanates, bis(isocyanatomethyl) cyclohexanes, toluenediisocyanates, methylene bis(4-phenyl isocyanate), phenylenediisocyanates, xylenediisocyanates, and a mixture of such diisocyanates. For example the diisocyanate may be an aromatic diisocyanate such phenylenediisocyanate, tolylenediisocyanate (TDI), xylylenediisocyanate, biphenylenediisocyanate, naphthylenediisocyanate, diphenylmethanediisocyanate (MDI), and combinations thereof.

The polyisocyanate component, suitable as another starting material for making urethane prepolymers according to the invention, can be an isomer mixture of diphenylmethane diisocyanate (MDI) containing 4,4′-methylene bis(phenyl isocyanate) and 2,4′- methylene bis(phenyl isocyanate) in the range of 4,4′-MDI to 2,4′-MDI isomer ratios of between about 65:35 to about 35:65, preferably in the range of about 55:45 to about 45:55 and more preferably at about 50:50. Examples of suitable polyisocyanate components include Mondur® ML (Bayer), Lupranate® MI (BASF), and Isonate® 50 O,P′ (Dow Chemical).

### Diols

Diol compounds, suitable as further starting materials for preparing urethane prepolymers according to the invention, include at least one diol compound with: (i) two hydroxy groups capable of reacting with the polyisocyanates; and (ii) at least one carboxylic acid group capable of forming salt upon neutralization and incapable of reacting with the polyisocyanates (b). Typical examples of diol compounds having a carboxylic acid group, include 2,2-dimethylopropionic acid (DMPA), 2,2-dimethylobutanoic acid, 2,2-dimethylovaleric acid, and DMPA initiated caprolactones such as CAPA® HC 1060 (Solvay). DMPA is preferred in the present invention.

### Neutralizing Agents

Examples of suitable neutralizing agents to convert the acid groups to salt groups include: tertiary amines (such as triethylamine, N,N-diethylmethylamine, N-methylmorpholine, N,N-diisopropylethylamine, and triethanolamine) and alkali metal hydroxides (such as lithium, sodium and potassium hydroxides). Primary and/or secondary amines may be also used as the neutralizing agent for the acid groups. The degrees of neutralization are generally between about 60% to about 140%, for example, in the range of about 80% to about 120% of the acid groups.

### Chain Extenders

The chain extenders useful with the present invention include diamine chain extenders and water. Many examples of useful chain extenders are known by those of ordinary skill in the art. Examples of suitable diamine chain extenders include: 1,2-ethylenediamine, 1,4-butanediamine, 1,6-hexamethylenediamine, 1,12-dodecanediamine, 1,2-propanediamine, 2-methyl-1,5-pentanediamine, 1,2-cyclohexanediamine, 1,4-cyclohexanediamine, 4,4′-methylene-bis(cyclohexylamine), isophorone diamine, 2,2-dimethyl-1,3-propanediamine, meta-tetramethylxylenediamine, and Jeffamine® (Texaco) of molecular weight less than 500. When a polyurethane is desired, a diol chain extender may be included.

### Surface Active Agents

Examples of suitable surface active agents (surfactants) include: anionic, cationic, or nonionic dispersants or surfactants, such as sodium dodecyl sulfate, sodium dioctyl sulfosuccinate, sodium dodecylbenzenesulfonate, ethoxylated alkylphenols such as ethoxylated nonylphenols, and ethoxylated fatty alcohols, lauryl pyridinium bromide, polyether phosphates and phosphate esters, modified alcohol-ethoxylates, and combinations thereof.

### Blocking Agents

A blocking agent for isocyanate groups may be either a monofunctional alcohol or a monofunctional amine. The blocking agent may be added at any time prior to formation of the prepolymer, during the formation of the prepolymer, or after the formation of the prepolymer including before and after dispersing the prepolymer into an aqueous medium such as deionized water. In some embodiments, the blocking agent is optional, or may be excluded. In other embodiments, based on the weight of the prepolymer, the blocking agent may be included in an amount from about 0.05% to about 10.0%, including about 0.1% to about 6.0% and about 1.0% to about 4.0%. Based on the weight of the final dispersion, the blocking agent may be present in an amount from about 0.01% to about 6.0%, including about 0.05% to about 3%, and about 0.1% to about 1.0%.

The inclusion of a blocking agent permits control over the weight average molecular weight of the polymer in the dispersion as well as providing control over the polymer molecular weight distribution. The effectiveness of the blocking agent to provide this control depends on the type of the blocking agent and when the blocking agent is added during the preparation of the dispersion. For example, a monofunctional alcohol may be added prior to the formation of the prepolymer, during or after the formation of the prepolymer. The monofunctional alcohol blocking agent may also be added to the aqueous medium into which the prepolymer is dispersed, or immediately following the dispersion of the prepolymer into the aqueous medium. However, when control over the polymer molecular weight and the molecular weight distribution in the final dispersion is desired, the monofunctional alcohol may be most effective if added and reacted as part of the prepolymer before it is dispersed. If the monofunctional alcohol is added to the aqueous medium during or after dispersing the prepolymer, its effectiveness in controlling the polymer molecular weight will be reduced due to the competing chain extension reaction.

Examples of monofunctional alcohols useful with the present invention include at least one member selected from the group consisting of aliphatic and cycloaliphatic primary and secondary alcohols with 1 to 18 carbons, phenol, substituted phenols, ethoxylated alkyl phenols and ethoxylated fatty alcohols with molecular weight less than about 750, including molecular weight less than 500, hydroxyamines, hydroxymethyl and hydroxyethyl substituted tertiary amines, hydroxymethyl and hydroxyethyl substituted heterocyclic compounds, and combinations thereof, including furfuryl alcohol, tetrahydrofurfuryl alcohol, N-(2-hydroxyethyl)succinimide, 4-(2-hydroxyethyl)morpholine, methanol, ethanol, butanol, neopentyl alcohol, hexanol, cyclohexanol, cyclohexanemethanol, benzyl alcohol, octanol, octadecanol, N,N-diethylhydroxylamine, 2-(diethylamino)ethanol, 2-dimethylaminoethanol, and 4-piperidineethanol, and combinations thereof.

When a monofunctional amine compound, such as a monofunctional dialkyl amine is used as a blocking agent for isocyanate groups, it may also be added at any time during preparation of the dispersion, desirably the monofunctional amine blocking agent is added to the water medium during or after the prepolymer dispersion. For example, the monofunctional amine blocking agent can be added to the water mixture immediately after the prepolymer is dispersed.

Examples of suitable mono-functional dialkylamine blocking agents include: N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tert-butyl-N-isopropylamine, N-isopropyl-N-cyclohexylamine, N-ethyl-N-cyclohexylamine, N,N-diethanolamine, and 2,2,6,6-tetramethylpiperidine. The molar ratio of the amine blocking agent to the isocyanate groups of the prepolymer prior to dispersion in water generally should range from about 0.05 to about 0.50, for example from about 0.20 to about 0.40. Catalysts may be used for the de-blocking reactions.

Optionally at least one polymeric component (MW>about 500), with at least three or more primary and/or secondary amino groups per mole of the polymer, may be added to the water medium after the prepolymer is dispersed and the blocking agent is added. Examples of the suitable polymeric component include polyethylenimine, poly(vinylamine), poly(allylamine), and poly(amidoamine) dendrimers, and combinations thereof.

### Other Additives

Examples of suitable antifoaming or defoaming or foam controlling agents include: Additive 65 and Additive 62 (silicone based additives from Dow Corning), FoamStar® I 300 (a mineral oil based, silicone free defoamer from Cognis) and Surfynol™ DF 110L (a high molecular weight acetylenic glycol non-ionic surfactant from Air Products & Chemicals).

Examples of suitable rheological modifiers include: hydrophobically-modified ethoxylate urethanes (HEUR), hydrophobically-modified alkali swellable emulsions (HASE), and hydrophobically-modified hydroxy-ethyl cellulose (HMHEC).

Other additives that may be optionally included in the aqueous dispersion or in the prepolymer include: anti-oxidants, UV stabilizers, colorants, pigments, crosslinking agents, phase change materials (i.e., Outlast®, commercially available from Outlast Technologies, Boulder, Colo.), antimicrobials, minerals (i.e., copper), microencapsulated well-being additives (i.e., aloe vera, vitamin E gel, aloe vera, sea kelp, nicotine, caffeine, scents or aromas), nanoparticles (i.e., silica or carbon), calcium carbonate, flame retardants, antitack additives, chlorine degradation resistant additives, vitamins, medicines, fragrances, electrically conductive additives, and/or dye-assist agents. Other additives which may be added to the prepolymer or the aqueous dispersion comprise adhesion promoters, anti-static agents, anti-cratering agents, anti-crawling agents, optical brighteners, coalescing agents, electroconductive additives, luminescent additives, flow and leveling agents, freeze-thaw stabilizers, lubricants, organic and inorganic fillers, preservatives, texturizing agents, thermochromic additives, insect repellants, and wetting agents.

Optional additives may be added to the aqueous dispersion before, during, or after the prepolymer is dispersed.

In the prepolymer mixing process, the prepolymer can be prepared by mixing starting materials, namely the polyol, the polyisocyanate and the diol compound together in one step and by reacting at temperatures of about 50° C. to about 100° C. for adequate time until all hydroxy groups are essentially consumed and a desired % NCO of the isocyanate group is achieved. Alternatively, this prepolymer can be made in two steps by first reacting a polyol with excess polyisocyanate, followed by reacting with a diol compound until a final desired % NCO of the prepolymer is achieved. For example, the % NCO may range from about 1.3 to about 6.5, such as from about 1.8 to about 2.6. Significantly, no organic solvent is necessary, but may be added or mixed with the starting materials before, during or after the reaction. Optionally, a catalyst may be used to facilitate the prepolymer formation.

In some embodiments, the prepolymer includes a polyol, a polyisocyanate, and a diol which are combined together and provided in the following ranges of weight percentages, based on the total weight of the prepolymer:

about 34% to about 89% of polyol, including from about 61% to about 80%;
about 10% to about 59% of polyisocyanate, including from about 18% to about 35%; and
about 1.0% to about 7.0% of diol compound, including from about 2.0% to about 4.0%.

A monofunctional alcohol may be included with the prepolymer in order to control the weight average molecular weight of the polyurethaneurea polymer in the complete dispersion.

The prepolymer prepared from the polyol, polyisocyanate, diol compound and optionally a blocking agent such as a monofunctional alcohol, may have a bulk viscosity (with or without solvent present) below about 6,000 poises, including below about 4,500 poises, measured by the falling ball method at 40° C. This prepolymer, containing carboxylic acid groups along the polymer chains (from the diol compound), can be dispersed with a high-speed disperser into a de-ionized water medium that includes: at least one neutralizing agent, to form an ionic salt with the acid; at least one surface active agent (ionic and/or non-ionic dispersant or surfactant); and, optionally, at least one chain extension component. Alternatively, the neutralizing agent can be mixed with the prepolymer before being dispersed into the water medium. At least one antifoam and/or defoam agent and/or at least one rheological modifier can be added to the water medium before, during, or after the prepolymer is dispersed.

Polyurethane aqueous dispersions may have a wide range of solids contents depending on the desired end use of the dispersion. Examples of suitable solids contents for the dispersions of some embodiments include from about 10% to about 50% by weight, for example from about 30% to about 45% by weight.

The viscosity of polyurethane aqueous dispersions may also be varied in a broad range from about 10 centipoises to about 100,000 centipoises depending on the processing and application requirements. For example, in one embodiment, the viscosity is in the range of about 500 centipoises to about 30,000 centipoises. The viscosity may be varied by using an appropriate amount of thickening agent, such as from about 0 to about 2.0 wt %, based on the total weight of the aqueous dispersion.

In the solvent process or acetone process, an organic solvent may also be used in the preparation of films and dispersions of some embodiments. The organic solvent may be used to lower the prepolymer viscosity through dissolution and dilution and/or to assist the dispersion of solid particles of the diol compound having a carboxylic acid group such as 2,2-dimethylopropionic acid (DMPA) to enhance the dispersion quality. It may also serve the purposes of improving the film uniformity such as reducing streaks and cracks in the coating/film-forming process.

The solvents selected for these purposes are substantially or completely non-reactive to isocyanate groups, stable in water, and have a good solubilizing ability for DMPA, the formed salt of DMPA and triethylamine, and the prepolymer. Examples of suitable solvents include N-methylpyrrolidone, N-ethylpyrrolidone, dipropylene glycol dimethyl ether, propylene glycol n-butyl ether acetate, N,N-dimethylacetamide, N,N-dimethylformamide, 2-propanone (acetone) and 2-butanone (methylethylketone or MEK).

In the solvent process, the amount of solvent added to the films/dispersion of some embodiments may vary. When a solvent is include, suitable ranges of solvent include amounts of less than 50% by weight of the dispersion. Smaller amounts may also be used such as less than 20% by weight of the dispersion, less than 10% by weight of the dispersion, less than 5% by weight of the dispersion and less than 3% by weight of the dispersion.

In the acetone process, a greater amount of solvent may be added to the prepolymer composition prior to the preparation of the dispersion. Alternatively, the prepolymer may be prepared in the solvent. The solvent may also be removed from the dispersion after dispersion of the prepolymer such as under vacuum.

There are many ways to incorporate the organic solvent into the dispersion at different stages of the manufacturing process, for example:
1) The solvent can be added to and mixed with the prepolymer after the polymerization is completed prior to transferring and dispersing the prepolymer, the diluted prepolymer containing the carboxylic acid groups (from the diol compound) in the backbone and isocyanate groups at the chain ends is neutralized and chain extended while it is dispersed in water.
2) The solvent can be added and mixed with other ingredients such as polyol, polyisocyanate and diol compound to make a prepolymer in the solution, and then this prepolymer containing the carboxylic acid groups in the backbone and isocyanate groups at the chain ends in the solution is dispersed in water and at the same time it is neutralized and chain extended.
3) The solvent can be added with a neutralized salt of a diol compound and a neutralizing agent and mixed with a polyol and polyisocyanate to make the prepolymer prior to dispersion.
4) The solvent can be mixed with TEA, and then added to the formed prepolymer prior to dispersion.
5) The solvent can be added and mixed with the polyol, followed by the addition of the diol compound and neutralizing agent, and then the polyisocyanate in sequence to a neutralized prepolymer in solution prior to dispersion.
6) The solvent may also be removed from the dispersion, especially in the case of the acetone process.

The coating, dispersion, film or shaped article derived from a polyurethane dispersion may be pigmented or colored and also may be used as a design element.

Methods and means for applying the polyurethaneurea compositions of some embodiments include, but are not limited to: roll coating (including reverse roll coating); use of a metal tool or knife blade (for example, pouring a dispersion onto a substrate and then casting the dispersion into uniform thickness by spreading it across the substrate using a metal tool, such as a knife blade); spraying (for example, using a pump spray bottle); dipping; painting; printing; stamping; and impregnating the article. These methods can be used to apply the dispersion directly onto a substrate without the need of further adhesive materials and can be repeated if additional/heavier layers are required. The dispersions can be applied to any substrate, including a mold or a fabric. A fabric may include knits, wovens or nonwovens made from synthetic, natural, or synthetic/natural blended materials for coating, bonding, lamination and adhesion purposes.

The water in the dispersion can be eliminated with drying during the processing (for example, via air drying or use of an oven). The article may be cured under any suitable conditions. This may include a temperature up to about 200° C., such as about 140° C. to about 200° C. for any suitable time including about 90 seconds to about 120 seconds.

The thickness of the films, solutions, and dispersions may vary depending on the application. In the case of molded articles, the final thickness for each layer of film may, for example, range from about 0.1 mil to about 250 mil, such as from about 0.5 mil to about 25 mil, including from about 1 to about 6 mil (one mil=one thousandth of an inch). Additional examples of suitable thicknesses include about 0.5 mil to about 12 mil, about 0.5 to about 10 mil, and about 1.5 mil to about 9 mil.

The aqueous dispersions can be applied to the substrate or mold in any suitable amount, described by the weight of the dispersion over unit area. The amount used may, for example, range from about 2.5 g/m² to about 6.40 kg/m², such as from about 12.7 to about 635 g/m², including from about 25.4 to about 152.4 g/m².

A method for preparing a article may include first providing a suitable substrate or mold to which a surfactant or wetting agent is applied. This is followed by the addition of an array of fibers that may be added by any suitable process. U.S. Pat. No. 3,917,883 describes one suitable method for providing the array of fibers onto the mold surface. This may be accomplished through electrostatic means such that the fibers are oriented substantially vertically with respect to the mold or substrate because of the influence of the electrostatic field. These fibers may be provided in any desired manner. This could include a substantially uniform distribution or a pattern. When oriented in this manner the ends of the fibers may extend beyond a surface of the cured/dried dispersion in the article.

The polyurethane dispersion may be added by any suitable process such as spraying, painting, coating, etc. additional layers of fiber or polyurethane dispersion may be added followed by a final layer of an array of fibers. Any suitable number of layers may be included such as from 1 to 50 layers, depending on the desired thickness and other properties.

Alternatively, fibers may be combined with the dispersion in another manner. This can include the combination of the dispersion with fibers to provide an article that may be molded. They fibers may also be prepared as a nonwoven fabric including dispersion, such as a spun bond or melt bond fabric. In preparation, the fiber/dispersion combination may be applied to a substrate such as a belt/conveyor belt.

End articles that can be produced using the dispersions and shaped articles include, but are not limited to: apparel, which includes any type of garment or article of clothing; knitted gloves; upholstery; hair accessories; bed sheets; carpet and carpet backing; conveyor belts; medical applications, such as stretch bandages; personal care items, including incontinence and feminine hygiene products; and footwear.

Examples of apparel or garments that can be produced using the dispersions and shaped articles falling within the scope of the present invention, include but are not limited to: undergarments, brassieres, panties, lingerie, swimwear, shapers, camisoles, hosiery, sleepwear, aprons, wetsuits, ties, scrubs, space suits, uniforms, hats, garters, sweatbands, belts, activewear, outerwear, rainwear, cold-weather jackets, pants, shirtings, dresses, blouses, mens and womens tops, sweaters, corsets, vests, knickers, socks, knee highs, dresses, blouses, aprons, tuxedos, bisht, abaya, hijab, jilbab, thoub, burka, cape, costumes, diving suit, kilt, kimono, jerseys, gowns, protective clothing, sari, sarong, skirts, spats, stola, suits, straitjacket, toga, tights, towel, uniform, veils, wetsuit, medical compression garments, bandages, suit interlinings, waistbands, and all components therein.

Another aspect of the invention is an article comprising the shaped article and a substrate wherein the shaped article and the substrate are attached to form a laminate whereby coefficient of friction of the elastic laminate is greater than that of the substrate alone. Examples of this are a waistband with a coating or film comprising the aqueous polyurethane dispersion which prevents slippage of the garment from another garment such as a blouse or shirt, or alternately prevents slippage of the waistband on the skin of the garment wearer.

Another aspect of the invention is an article comprising a polyurethaneurea composition and a substrate wherein the modulus of the shaped article varies along the length, or alternately the width, of the article. For example, a substrate such as fabric can be treated with two feet (61 cm) of a polyurethaneurea composition such as a one inch (2.5 cm) wide adhesive tape. An additional layer of adhesive can be applied by painting three two inches (5 cm) by one inch segments along the length of the one inch wide adhesive tape to form composite structure.

Articles formed from the aqueous polyurethane dispersions, may have the following properties:
set after elongation of from about 0 to 10%, for example from about 0 to 5%, typically from about 0 to about 3%,
elongation of about 400 to about 800%,
tenacity of about 0.5 to about 3 Mpa,
air permeability of at least about 0 to about 0.5 cfm or greater, and
moisture vapor permeability of at least about 0 to about 500 g/m² over 24 hours, including from about 50 to about 1000 g/m2 over 24 hours, or about 100 to about 500 g/m2 over 24 hours. Moisture Vapor Transmission may be tested according to ASTM Designation E 96-00 “Standard Test Methods for Water Vapor Transmission of Materials.”

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

1. An article comprising a polyurethane composition and an array of fibers wherein said array of fibers are embedded in said polyurethane composition such that a portion of said fibers extends beyond an internal surface of said molded article and an external surface of said molded article.

2. The article of claim 1, having moisture vapor transport of about 100 g/m² over 24 hours or greater.

3. The article of claim 1, wherein said polyurethane composition is formed from a polyurethane dispersion.

4. The article of claim 1, wherein the article is molded.

5. A method for preparing an article comprising:
(a) providing a substrate having an article contacting surface, wherein said article contacting surface includes a surfactant or wetting agent;
(b) applying an internal array of fibers to the article contacting surface;
(c) applying a polyurethane dispersion to said array of fibers;
(d) applying an external array of fibers to said dispersion;
(e) drying said article;
(f) removing said article from said substrate.

6. The method of claim 5, wherein the substrate is a mold.

7. The method of claim 5, further comprising applying more than one additional layer of polyurethane dispersion prior to applying said external array of fibers.

8. The method of claim 7, further comprising applying one or more additional arrays of fibers prior to adding one or more additional layer of polyurethane dispersion.

9. The method of claim 5, wherein said polyurethane dispersion comprises a polyurethaneurea.

10. The method of claim 5, wherein said internal array of fibers and said external array of fibers are embedded in a polyurethane dispersion layer and extend partially beyond an internal and an external surface of said article.

11. The method of claim 5, wherein said article is selected from the group consisting of a garment, a sleeve, a bandage, and a glove.
